(19) United States
(12) Patent Application Publication
(10) Pub. No.: US 2009/0151467 A1
(43) Pub. Date: Jun. 18, 2009

(54) DETECTOR DEVICE WITH SENSOR STRAND

(75) Inventor: Harald Heimerl, Augsburg (DE)

Correspondence Address: DOBRUSIN & THENNISCH PC, 29 W LAWRENCE ST, SUITE 210, PONTIAC, MI, 48342, US

(73) Assignee: W.E.T. AUTOMOTIVE SYSTEMS AG

(21) Appl. No.: 12/333,649

(22) Filed: Dec. 12, 2008

(30) Foreign Application Priority Data
Dec. 14, 2007 (DE) 202007017622.8
Jan. 21, 2008 (DE) 102008005387.2

(51) Int. Cl. G01L 1/00

(52) U.S. Cl. 73/781

(57) ABSTRACT

This invention relates to a detector device with at least one sensor strand, which has at least one measuring section for detecting a measurable variable, and which has at least one connecting section in order to connect at least one measuring section to a further electrical device. Provision is made for the sensor strand to have numerous conductor strands in at least one measuring section and in at least one connecting section, and, at least in the measuring section, for at least two conductor strands to be isolated at least partially from their surroundings by a common moisture-protection barrier, and, at least in the connecting section, for at least one conductor strand to be at least partially isolated from at least one other conductor strand by a moisture-protection barrier.

### CLAIM OF PRIORITY

The present application claims priority from German Application Nos. DE 202007017622.8, filed on Dec. 14, 2007 and DE 102008005387.2, filed on Jan. 21, 2008, disclosure of which is hereby incorporated by reference herein.

### FIELD OF THE INVENTION

This invention relates to a detector device with at least one sensor strand, which has at least one measuring section for detecting a measurable variable and which has at least one connecting section in order to connect at least one measuring section to a further electrical device. More particularly, in that the sensor strand has a multitude of conductor strands in at least one measuring section and in at least one connecting section, that in at least one measuring section at least two conductor strands are at least partially isolated from their surroundings by a common moisture-protection means, and that in at least one connecting section at least one conductor strand is at least partially isolated from at least one other conductor strand by a moisture-protection means.

### BACKGROUND

The subject matter of this invention includes a detector device with at least one sensor strand, which has at least one measuring section for detecting a measurable variable and which has at least one connecting section in order to connect at least one measuring section to a further electrical device. For example, detector devices of this kind are used to detect passengers on vehicle seats.

They have the disadvantage that for some applications, their measuring accuracy is not as high as desired. In addition to keeping production costs low, it is therefore desirable to improve the measuring accuracy.

### SUMMARY

Against this background, a technical idea incorporating the features of the below aspects is proposed. Further advantageous embodiments are evident from the following description.

Accordingly, pursuant to one aspect of the present invention, there is contemplated a detector device with at least one sensor strand, which has at least one measuring section for detecting a measurable variable and which has at least one connecting section in order to connect at least one measuring section to a further electrical device, characterized in that the sensor strand has a multitude of conductor strands in at least one measuring section and in at least one connecting section, that in at least one measuring section at least two conductor strands are at least partially isolated from their surroundings by a common moisture-protection means, and that in at least one connecting section at least one conductor strand is at least partially isolated from at least one other conductor strand by a moisture-protection means.

The invention may be further characterized by one or any combination of the features described herein, such as at least one measuring section and at least one connecting section are made from one piece, and both have at least one moisture protection means for at least partial isolation of several conductor strands from their surroundings, and at least one moisture-protection means for at least partial isolation of at least one conductor strand from at least one other conductor strand; at least one measuring section and at least one connecting section are joined at a connection point, and that the connection point is sealed off at least partially from its surroundings by an air tight and/or vapor tight seal; at least one measuring section has at least one conductor strand containing a ferrous material; at least one connecting section has at least one conductor strand containing a share of copper; at least one moisture-protection means has at least shares of extruded plastics, lacquer and/or waxes; seat has a detector device.

Details of the invention are explained in the following. These explanations are intended to elucidate the invention. However, they are only of exemplary nature. The scope of the invention naturally allows for one or more of the described features to be omitted, modified or augmented. And it goes without saying that the features of different embodiments can be combined with each other. What is crucial is that the idea behind the invention is essentially implemented. “Essentially” as used here means particularly that implementation permits the desired usefulness to be achieved to a recognizable extent. This can mean, in particular, that a specific feature is fulfilled to an extent of at least 50%, 90%, 95% or 99%.

### BRIEF DESCRIPTION OF THE DRAWINGS

Reference will be made hereinafter to:

FIG. 1 is an illustrative Top view of the seating area of a seat (without the cover).

FIG. 2 is an illustrative Cross section of a sensor strand in a measuring section.

FIG. 3 is an illustrative Cross section of a sensor strand in a connecting section.

### DETAILED DESCRIPTION

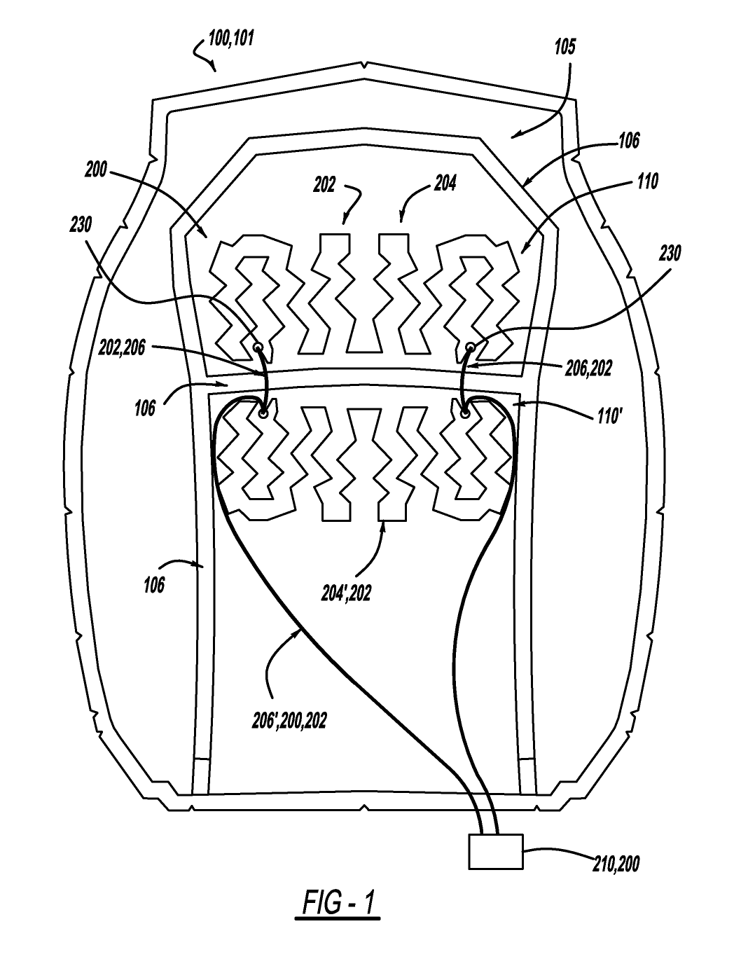

FIG. 1 shows the seating area 101 of a vehicle seat 100. The seating area 101 has cushion portions 105, at which the seating area 101 is cushioned. Trenches 106 keep the cushion portions 105 spaced apart from each other.

Measuring zones 110, 110′ intended for detecting the presence of a person are arranged in at least two cushion portions 105′.

The seat 100 is provided with at least one detector device 200, which serves for the detection of persons on the seat. The detector device may be one that merely detects the presence of a seat occupant, or one that can differentiate between certain types (baby seat, child, adult, etc) and/or can determine properties such as position or weight.

The detector device 200 has at least one sensor strand 202. A strand is a longish structure whose longitudinal dimensions by far exceed its cross-sectional dimensions. Preferably, the two cross-sectional dimensions are approximately the same size. The structure preferably has bending-elastic properties, but is in a solid state.

The sensor strand 202 has at least a first measuring section 204, which is arranged at least partially in a measuring zone 110 of the seat 100. The sensor strand 202 preferably has at least one additional measuring section 204′, which is arranged at least partially in a second measuring zone 110′ of the seat 100.

The two measuring sections 204, 204′ are connected with each other at one end by means of a first connecting section 206. In the embodiment, they are connected with each other at the other end, too, by means of another connecting section 206. However, they may also be connected with other measuring sections in other measuring zones.

At least one measuring section 204, 204′ is directly or indirectly connected with an evaluation unit 210 via a further connecting section 206′. This electronically evaluates the measuring signals from the measuring sections 204, 204′.

For measuring purposes, the two ends of a measuring section 204, 204′ may be connected to electrical potentials that differ from one another. In this case, the sensor strand 202, i.e. the measuring sections 204, 204′, serves for example to detect changes in its electromagnetic field. However, the two ends of a measuring section 204, 204′, i.e. of the sensor strand 202, can also be connected to the same electrical potential. In this case, the conductor loop of the sensor strand 202 forms a pole of a measuring capacitor. The other pole may be formed, for example, by a grounded terminal, the vehicle roof, the surrounding bodywork or other sensor strands.

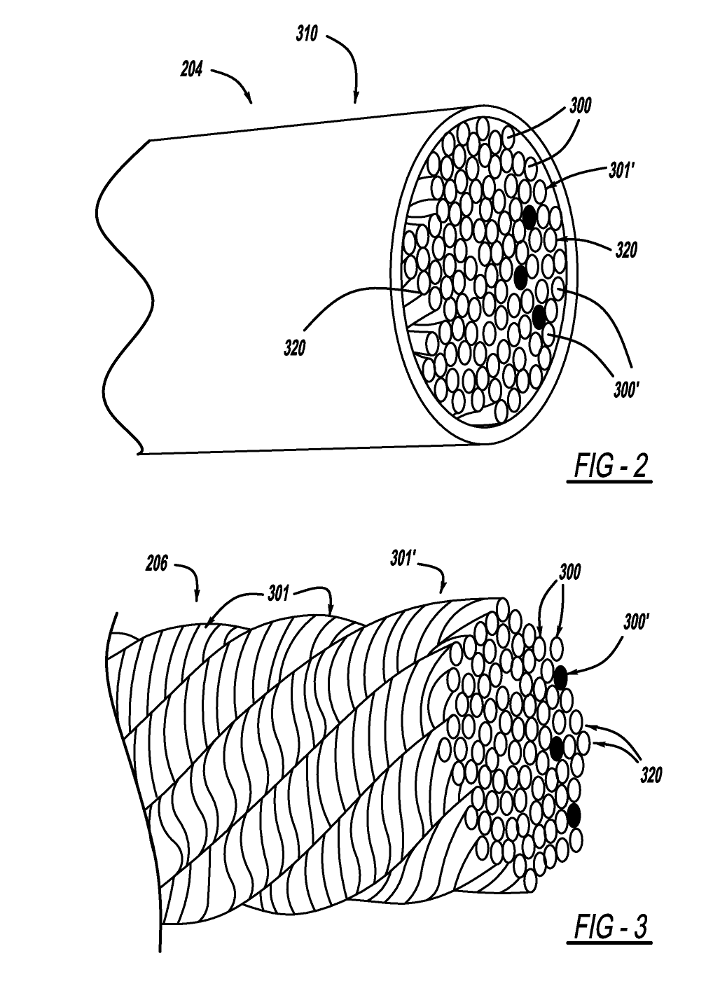

FIG. 2 shows a measuring section 204 of a sensor strand 202. The measuring section 204 has numerous conductor strands 300. These are isolated at least partially from their surroundings by a common moisture-protection barrier 310. Provision may be made for at least one conductor strand 300′ to be isolated at least partially from at least one other conductor strand 300 of the measuring section 204 by an additional moisture-protection barrier 320. At least one conductor strand 300, 300′, preferably most, preferably all of them are made at least partially, preferably mostly, of a ferrous material, preferably stainless steel,

FIG. 3 shows a connecting section 206 of a sensor strand 202. The connecting section 206 may preferably have numerous conductor strands 300. These may be isolated at least partially from their surroundings by a common moisture-protection barrier (not shown). At least one conductor strand 300′ (preferably all) is isolated at least partially by barrier of a moisture-protection barrier 320 from at least one other conductor strand 300 of the measuring section 204. At least one conductor strand 300, 300′, preferably most, preferably all of them, are made at least partially of a copper material, preferably of a copper material with a copper content of at least 90%.

FIG. 3 shows that the conductor strands 300, as first-order conductor strands, may be twisted with each other in such manner as to form second-order conductor strands 301. Here in the embodiment, these second-order conductor strands 301 together form a conductive strand that forms the connecting section 206. 206′ of the sensor strand 202. Of course, the measuring section 204, 204′ may also be configured with a structure of this kind.

The moisture-protection barrier 310, 320 are preferably fabricated as different components and from different materials. However, they may also be formed by one and the same component, and be made of one and the same material.

At least one connecting section 206, 206′ and at least one measuring section 204, 204′ may be formed from a coherent conductor strand. As here in the embodiment, however, they may also be formed from two different strands joined at a connection point 230. At this connection point 230, at least some of the conductor strands of the measuring section 204, 204′ are connected in electrically conducting manner with at least some of the conductor strands 300, 300′, 301 of the connecting section 206, 206′. It is also expedient to seal off the connection point from the surroundings such as to make it as impermeable as possible to water and water vapor and thus to prevent any ingress of water into the sensor strand. This would alter its electrical properties and hence the detector device's measured values.

### REFERENCE NUMERALS

100 Seat

101 Seating area

105, 105° Cushion portion

106 Trench

110, 110′ Measuring zone

200 Detector device

202 Sensor strand

204, 204′ Measuring section

206, 206° Connecting section

210 Evaluation unit

230 Connection point

300, 300° First-order conductor strand

301 Second-order conductor strand

310 Moisture-protection barrier

320 Internal moisture-protection barrier

1. A detector device comprising:
at least one sensor strand; and
a plurality of conductor strands;
wherein the at least one sensor strand includes at least one measuring section for detecting a measurable variable and which includes at least one connecting section in order to connect the at least one measuring section to a further electrical device, further wherein the detector device includes the plurality of conductor strands in the at least one measuring section and in the at least one connecting section;
wherein the at least one measuring section and at least two of the plurality of conductor strands are at least partially isolated from their surroundings by a common moisture-protection barrier, and that in the at least one connecting section and the at least one of the plurality of conductor strands is at least partially isolated from at least one of the other conductor strands by a moisture-protection barrier.

2. The detector device according to claim 1, characterized in that the at least one measuring section and the at least one connecting section are made from one piece.

3. The detector device according to claim 1, characterized in that the at least one measuring section and the at least one connecting section are joined at a connection point and that the connection point is sealed off at least partially from its surroundings by a fluid tight seal.

4. The detector device according to claim 1, characterized in that the at least one measuring section includes at least one conductor strand containing a ferrous material.

5. The detector device according to claim 1, characterized in that at least one connecting section includes at least one conductor strand containing a share of copper.

6. The detector device according to claim 1, characterized in that the at least one moisture-protection barrier includes at least shares of extruded plastics, lacquer and/or waxes.
